(19) United States
(12) Patent Application Publication
(10) Pub. No.: US 2004/0249658 A1
(43) Pub. Date: Dec. 9, 2004

(54) Services integration

(76) Inventors: Sven Schwerin-Wenzel, Dielheim (DE); Eric Wood, Menlo Oaks, CA (US); Nir Kol, Sunnyvale, CA (US); Dennis B. Moore, Burlingame, CA (US)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/768,967

(22) Filed: Jan. 30, 2004

Related U.S. Application Data
(60) Provisional application No. 60/455,087, filed on Mar. 14, 2003.

(51) Int. Cl. G06F 17/60

(52) U.S. Cl. 705/1

(57) ABSTRACT

Systems and techniques relating to software for enterprise change, in particular to merger and acquisition processes and tools for one or more organizations. A method for managing a corporate restructuring of at least two organizations includes presenting a user interface including information relating to consolidating customer accounts for at least one of the restructuring organizations, and presenting a template in the user interface, the template including a rollout template menu, a pull down window, a list of action items, and a status relating to each action item in the list.

### CROSS REFERENCE TO RELATED APPLICATIONS

This application claims priority to U.S. Provisional Application entitled “ENTERPRISE CHANGE PLANNING AND EXECUTION,” filed on Mar. 14, 2003, Application Ser. No. 60/455,087.

### BACKGROUND

During an organizational restructuring, such as a merger or acquisition, an organization needs to determine how to effectively serve current customers. In order to obtain one or more restructuring goals, organizations often desire to share customer information and resources to reduce the risk of unwanted redundant customer services and support. Moreover, organizations want to ensure that customer concerns are addressed in the restructuring process.

### SUMMARY

The present application describes systems, methods and software for enterprise change, such as mergers & acquisitions (M&As), for one or more organizations.

In an aspect, the invention features a method for managing a corporate restructuring of at least two organizations including presenting a user interface including information relating to consolidating customer accounts for at least one of the restructuring organizations, and presenting a template in the user interface, the template including a rollout template menu, a pull down window, a list of action items, and a status relating to each action item in the list.

In embodiments, the list of action items can include at least one of an account executive assignment notification, an account executive personalized communication, a customer communication, a cross selling opportunity, and a retention plan, an action including a transmission of an email.

In another aspect, the invention features a method including providing a single logical physically distributed information system across one or more information systems of at least two enterprises being combined, and providing a user interface to allow a user to access the single logical physically distributed information system to execute one or more pre-merger activities, merger activities, and post-merger activities, the merger activities including customer-related integration and resources, the post-merger activities including a post-merger assessment and a measurement of one or more achieved merger synergies.

In embodiments, the merger activities can include providing customer-related communications, and managing and planning customer support activities, the customer support activities including addressing one or more customer issues and concerns. The user interfaces can be adapted to a role of the user and a phase of the merger, the user role including an executive of one or more customer accounts, a security of the user interface related to the phase of the merger and a role of the user.

In another aspect, the invention features a method including facilitating consolidation of customer-related information for a first organization being merged with a second organization, the customer-related information including customer accounts, the consolidation including matching one or more customer accounts of the organizations, and facilitating consolidation of customer-related assignments of at least one of the organizations.

In embodiments, the method can include providing an exception list for non-matched customer accounts, and tracking a status of customer-related engagements.

In another aspect, the invention features a system for managing a merger of at least two organizations, wherein the system can include a software process and user interface adapted to assist customer satisfaction during a merger period, the software process being stored in a medium.

In embodiments, the system can include a first tool adapted to retain one or more customers, a second tool adapted to provide collaborative customer retention planning, and/or a third tool to provide targeted and personalized electronic mailing to customers of at least one of the organization. The second tool can be adapted to provide a unified and aligned presentation of customer accounts from one or more merger customer support centers of at least one of the organizations, the presentation including customer records.

In another aspect, the invention features a system for implementing a merger of at least two organizations, the system including a software product adapted to facilitate sales-related activities of the organizations, the software product including a user interface, wherein the sales-related activities including at least one of sales consolidation, cross selling activities, and customer retention of the organizations.

In embodiments, the user interface presents at least one of a synergy, an expected impact, a realized impact, and a progress of the expected impact, the user interface presents the progress in a graph and at least one of an owner of the synergy, an electronic mailing link, and one or more initiatives related to the synergy. The user interface presents information for one or more user-identified cross selling opportunities, the information including a number of matched customer accounts, a status, and a potential value, the potential value associated with an external object. The user interface can include a first panel adapted to address customer-related issues, a second panel adapted to address sales-related initiatives, the second panel including at least one of an approval button, a rejection button, a checklist of initiatives, a number of impacted customers, a financial impact, an initiative owner, and an initiative priority level, a third panel adapted to facilitate customer retention, the third panel including a measure of customer retention, one or more retention rates, and a movement of the one or more rates, a fourth panel adapted to facilitate customer retention, the fourth panel including at least one of a customer satisfaction rate, a customer survey, and a movement of the rate, wherein the customer survey can include one or more external objects, and/or a fifth panel adapted to facilitate a search of merger information and to facilitate contacting one or more merger members.

In another aspect, the invention features a system for managing a merger of at least two organizations, the system including a graphical user interface adapted to allow a user to consolidate customer accounts for at least one of the organizations, the graphical user interface further adapted to match customer accounts from at least two merger organizations.

In embodiments, the graphical user interface can include a sorted list of customer accounts, a customer account value, a numerical representation of account ranking, information for at least one customer service personnel from each merger organization, information for a customer service personnel assignment relating to at least one account, the customer service personnel assignment including a cooperative assignment. The graphical user interface can also include information relating non-matched accounts and a clean room tool adapted for at least one stakeholder, the information relating to non-matched accounts including a second list of customer accounts.

In another aspect, the invention features a method for managing a merger of at least two organizations including presenting a user interface including information relating to consolidating accounts for at least one of the merger organizations, the user interface including a pull down window, a text box a trigger date, and a response date, and presenting a template in the user interface, the template including a notification template menu, a list of action items, and an owner relating to each action item in the list.

In embodiments, the list of action items can include at least one of an account executive assignment notification, an account executive personalized communication, a customer communication, a cross selling opportunity, and a retention plan, an action item includes transmission of an email.

The method can also include facilitating exception handling for at least one of the action items. The user interface can present at least one of a list and a graph, the graph presents a time period for each listed action.

In another aspect, the invention features a system for managing a merger of at least two organizations including a services unification module, the services unification module including one or more user roles, the user roles including at least one of customers, services taskforce members, service representatives, and integration project managers.

In embodiments, the services unification module can include one or more inputs, the inputs including a list of customer accounts, a list of products sold to one or more customers, a list of customer-related services, a list of customer-related personnel, and a list of service providers. The services unification module further can include one or more outputs, the outputs including an account services consolidation plan, a merged account repository, a customer communication, a tracking statistic, and a customer-satisfaction statistic.

Details of one or more implementations are set forth in the accompanying drawings and the description below. Other features and advantages can be apparent from the description, drawings, and claims.

### BRIEF DESCRIPTION OF THE DRAWINGS

These and other aspects will now be described in detail with reference to the following drawings.

FIG. 1 is a block diagram of a system.

FIG. 2 is a flow diagram.

FIG. 3 is a block diagram of an architecture.

FIG. 4 is a block diagram of a platform.

FIGS. 5-12 illustrate exemplary user interfaces.

Like reference symbols in the various drawings indicate like elements.

### DETAILED DESCRIPTION

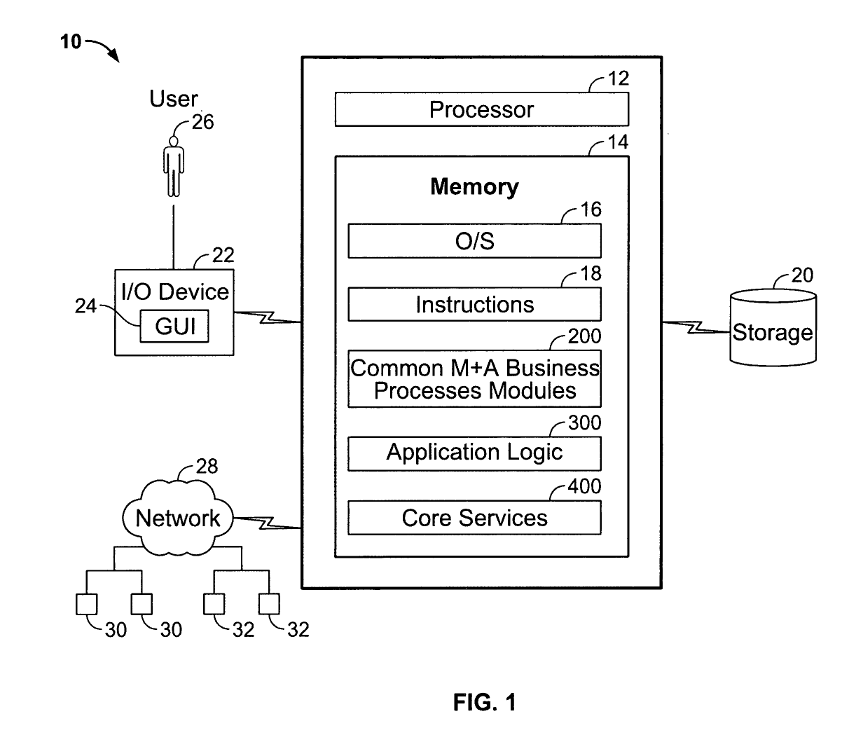

As shown in FIG. 1, a system 10 includes a processor 12 and a memory 14. Memory 14 includes an operating system 16, and instructions 18, that when executed by the processor 12, perform an exemplary restructuring integration process 100, described below. A specific restructuring process, referred to as a merger and acquisition (M&A), will be used as an example throughout this description. However, the process 100 can be applied to most corporate change or restructuring activities, such as spin-offs, department mergers and splits, and so forth. Memory 14 also includes common restructuring business processes modules 200, application logic 300, and a core framework of services 400 that support the restructuring integration process 100. The system 10 includes a link to a storage device 20 and an input/output device 22. The input/output device 22 can include a graphical user interface (GUI) 24 for display to a user 26.

The system 10 includes a link to a network 28. Network 28 links the system 10 to other systems 30 within a single entity and to systems 32 in one or more other entities. Systems 30, 32, generally referred to as clients or source systems, access data through a portal 34. Systems 10, 30, 32 are designed to act as a single logical physically distributed information system representing multiple enterprise information systems of organizations residing in the systems 30, 32. Information is exchanged between the system 10 and systems 30, 32 through the portal 34 and through user interfaces (UIs) of an architecture, described below.

As used herein, the terms “electronic document” and “document” mean a set of electronic data, including both electronic data stored in a file and electronic data received over a network.

The term “organization” refers to a company, enterprise, business, government, educational institution, or the like. The term “organization” can also refer to a group of persons, such as an association or society.

An “enterprise change” or “organization change” refers to a merger, an acquisition, a combination of a merger and acquisition or some other type of change in an organization's structure, leadership, governance, personnel, business, direction, purpose, strategy, and so forth.

A “synergy” is a value, performance or effect that can be achieved as resources of two organizations combined will be greater than the sum of the separate individual resources. The term “synergy” can also refer to cooperative interaction among groups, especially among the acquired subsidiaries or merged parts of an organization, which creates an enhanced combined effect.

The term “object” refers to information sources such as documents, reports, presentations, files and directories.

The system described herein can use software and structures available from SAP AG of Walldorf, Germany. Instead of or in addition to SAP AG software, the system can coexist or operate with software and systems that are not provided by SAP AG. For example, the disclosed software can include a hierarchal software framework to work seamlessly with other software tools such as Excel® made by Microsoft Corporation of Redmond, Wash.

The processes for merger members can include an intranet template for employees. In general, a “template” in the merger process is an interface that can include parameters or a format from a previous merger, or can be transferred or copied from another employee in the same organization or a customer.

“Stakeholders” are exemplary merger members described herein with an interest or stake in the progress of the merger, or persons who are involved in some aspect of the merger or its effects.

A “deliverable” is referred to as a “task” that one or more stakeholders are responsible for producing for other stakeholders. A deliverable can be referred to as a goal, objective, result or procedure that can be fulfilled, promised, achieved, produced or expected. A deliverable can also be referred to as a merger-related project.

Due diligence involves investigation and examination into one or more details of a potential investment, such as an examination of operations and management and a verification of material facts. Due diligence can serve to confirm material facts regarding a merger or offer, such as reviewing financial records and other items deemed material to the merger.

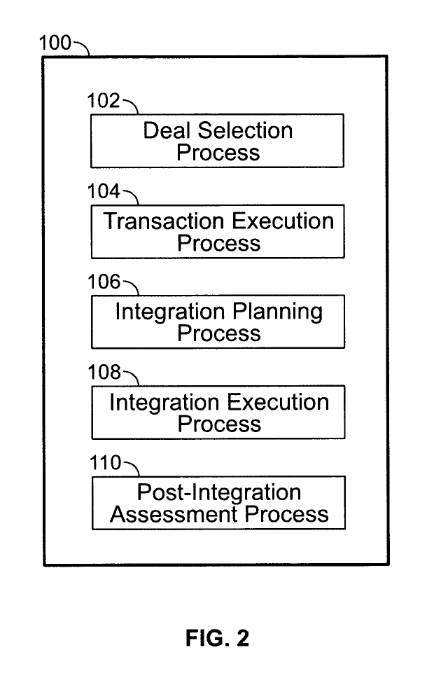

As shown in FIG. 2, the restructuring integration process 100 includes a deal selection process 102. The deal selection process 102 defines acquisition objectives and strategies. The deal selection process 102 searches for the best fit target company to meet a set of objectives and manages detailed due diligence on the target company. The deal selection process 102 also identifies synergies, risks and a realization plan for acquiring the target company.

A transaction execution process 104 structures an acquisition in terms of type, tax implications, legal issues and so forth. The transaction execution process 104 closes an acquisition deal and provides for a rollback in the event the acquisition deal fails.

An integration planning process 106 provides a plan for short term and long term tasks of acquisition integration and communicates goals and decisions to all stakeholders.

The restructuring integration process 100 includes an integration execution process 108. The integration execution process 108 manages an integration project and it sub-projects, designs a new organization, and minimizes disruptions to customers by rolling out combined field organizations quickly. The integration execution process 108 manages the integration of information technology (IT), human resources (HR), financials and procurement. The integration execution process 108 provides for the retention of key employees, manages field organization integration, and identifies cross-selling opportunities and rolls the opportunities out. The integration execution process 108 manages stakeholders, tracks an acquisition, and reports issues and successes.

The restructuring integration process 100 includes a post-integration assessment process 110. The post-integration assessment process 110 measures achieved synergies against targets, accesses where improvements can be made in synergy estimation and/or in integration execution, and applies history to a next transaction.

An enterprise change (e.g., merger or acquisition) is facilitated by treating two or more information systems as a single logical information system to execute pre-change (e.g., pre-deal, pre-closing or pre-merger) due diligence and post-change (e.g., post-deal, post-merger or post-closing) integration of the enterprise change (e.g., merger or acquisition).

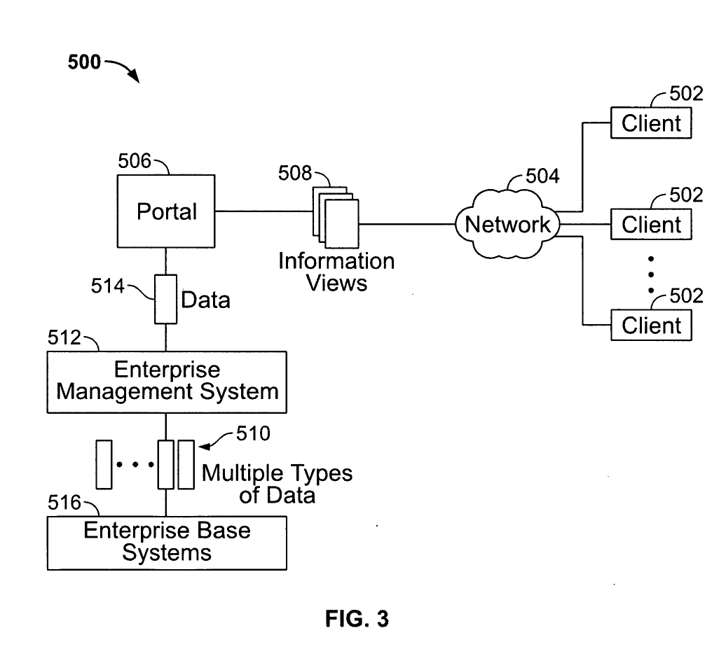

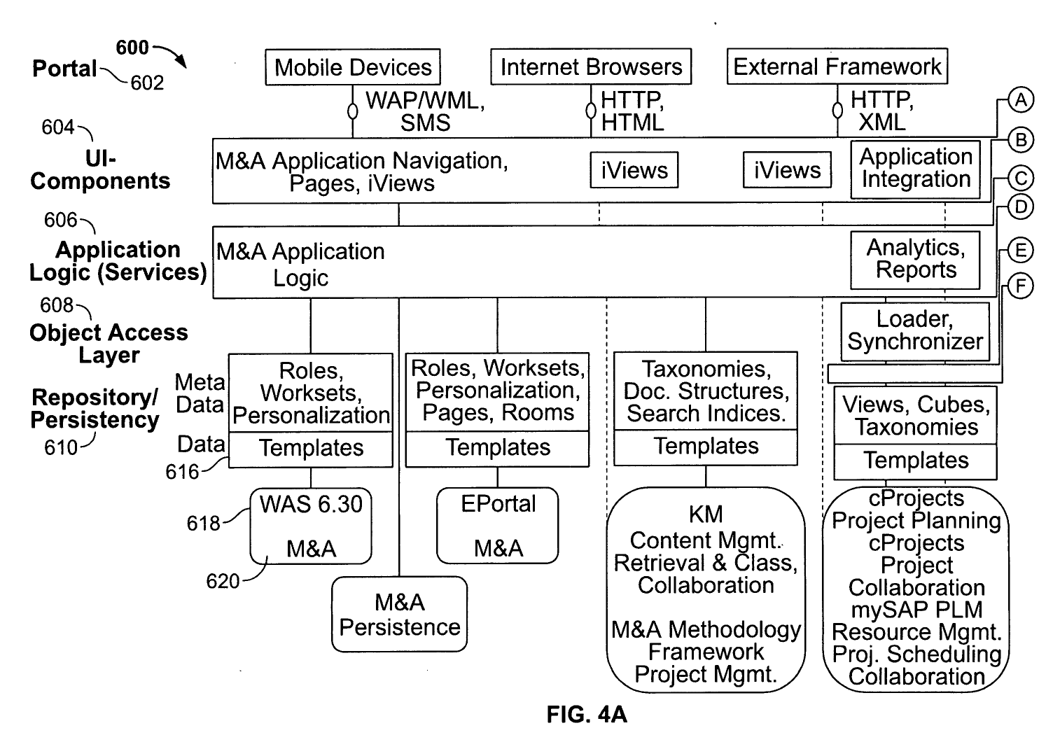

As shown in FIG. 3, the restructuring integration process 100, common restructuring business processes modules 200, application logic 300, and core framework of services 400 are designed to conform to an architecture 500 designed to a platform 600 that represents a single logical physically distributed information system representing multiple enterprise information systems of organizations. The architecture 500/platform 600 insure consistency of data exchange between system 10 and source systems 30, 32, and a separation of source systems 30, 32, when appropriate during phases of the restructuring integration process 100.

The single logical physically distributed information system architecture 500 representing multiple enterprise information systems of organizations includes multiple clients 502 accessing data over a network 504 through a portal 506. In one embodiment, the clients 502 are processes and/or web browsers that are coupled to the network 504 through a proxy server (not shown).

The portal 506 provides a common interface to program management services through user interface (UI) components 508. The portal 506 receives requests from the clients 502 and generates information views (iViews) 510, such as web pages, in response. In embodiments, the portal 506 implements a user roles-based system to personalize a common interface and the iViews 510 for a user of one of the clients 502. The user can have one or more associated roles that allow personalized tailoring of a presented interface through the iViews 510.

The portal 506 communicates with an enterprise management system 512 that consolidates multiple application services.

The portal 506 receives data 514 from the system 512 to fulfill the requests of the clients 502. The system 512 provides integrated application services to manage business objects and processes in a business enterprise. The business objects and processes include resources such as personnel, development projects, business programs, inventories, clients, accounts, business products, business services and so forth.

The system 512 communicates with enterprise base systems 516 to obtain multiple types of enterprise base system data 518. The base systems 516 include application services, such as human resource management systems, customer relationship management services, financial management systems, project management systems, knowledge management systems, business warehouse systems, time management systems, electronic file systems and mail systems. In embodiments, the enterprise base systems 516 include a single integration tool, such as eXchange from SAP AG of Germany, which provides an additional level of integration among the enterprise base systems 516. The enterprise management system 512 consolidates and integrates data and functionality of the enterprise base systems 516 into the single management tool.

The single management tool includes systems and methods to facilitate generation of new applications within the enterprise management system 512. The new applications, generally referred to as cross-functional or composite applications, draw on resources of the enterprise base systems 516 to cross over traditional application boundaries and handle new business scenarios in a flexible and dynamic manner.

A virtual business cycle can be generated using such composite applications, where executive level business strategy can feed management level operational planning, which in turn can feed employee level execution, which can feed management level evaluation, which can feed executive level enterprise strategy. Information generated in each of these stages in an enterprise management cycle can be consolidated and presented by the enterprise management system 512 using the customized cross-functional applications. The stages provide and consume determined services that are integrated across multiple disparate platforms.

The portal 506, enterprise management system 512 and enterprise base systems 516 can reside on one or more programmable machines, which communicate over the network 504 or one or more communication busses. In embodiments, the base systems 516 reside in multiple servers connected to the network 504, and the portal 506 and enterprise management system 512 reside in a server connected to a public network (not shown). Thus, the architecture 500 can include customized, web-based, cross-functional applications, and a user can access and manage enterprise programs and resources using these customized web-based, cross-functional applications from anywhere that access to the public network is available.

A user interface (UI) provides UI patterns used to link new objects and workflow together and generate standardized views into results generated by one or more cross-functional applications.

An object modeling tool enables generation of new business objects in a persistency/repository layer by providing a mechanism to extend a data object model dynamically according to the needs of an enterprise.

A process modeling tool enables generation of new business workflow and ad hoc collaborative workflow. The process modeling tool includes procedure templates with pre-configured work procedures that reflect best practices of achieving a work objective. A work procedure can include contributions from several individuals, generation of multiple deliverables, and milestones/phases. Whenever an instantiated business object or work procedure has a lifetime and status, a progress and status of the object or work procedure is trackable by a process owner or by involved contributors using a “dashboard” that displays highly aggregated data. The dashboard and a “myOngoingWork place” can be two UI patterns that are provided by the UI components 508.

Whenever there is a concept of “myObjects,” “myRecentObjects,” “myRelatedObjects” or “myPreferredObjects,” then an object picker UI pattern, provided by the UI components 508, is included that lets users pick their favorite object directly. Whenever people are to be searched, either for choosing one individual person or for generating a collection of people meeting some criterion, a “People Finder” concept can be applied. A key aspect of searching for a person is described as an attribute within the user's activity, qualification, interest, and collaboration profile. For a given cross-functional application, people collections can be stored as personal or shared collections using the People Finder to make them available for further operations later on.

Whenever there is a strategic view on a cross-functional application scenario, analytics of the overall portfolio can be made available in the form of a collection of the UI components 508. A view selector is used to display/hide components, and a component can be toggled between graphical and numerical display and include a drop-down list or menu to select sub-categories or different views.

Cross-functional application scenarios provide related information to the user when possible, and some parts within a larger cross-functional application define what kind of related information is to be offered. Heuristics can be used to identify such relatedness, such as follows: (1) information that is related to the user due to explicit collaborative relationships, such as team/project membership or community membership; (2) information that is similar to a given business object in a semantic space based on text retrieval and extraction techniques; (3) recent objects/procedures of a user; (4) other people doing the same or similar activity (using the same object or procedure template, having the same work set); (5) instances of the same object class; (6) next abstract or next detailed class; (7) explicit relationships on the organizational or project structure; (8) proximity on the time scale; (9) information about the underlying business context; and/or (10) information about the people involved in a collaborative process.

Cross-functional applications also can include generic functionality in the form of “Control Center Pages” that represent generic personal resources for each user. These cross-functional applications can refer to the following pages, where appropriate: (1) A “MyOngoingWork” page that provides instant access to all dashboards that let users track their ongoing work. Ongoing work refers to the state of business objects as well as guided procedures. (2) A “MyDay” page that lists today's time based events that are assigned or related to the user. (3) “MyMessageCenter” page that displays all pushed messages and work triggers using a universal inbox paradigm with user selected categorical filters. (4) “MyInfo” that provides access to all personal information collections (documents, business objects, contacts) including those located in shared folders of teams and communities of which the user is a member. MyInfo can also provide targeted search in collaborative information spaces such as team rooms, department home pages, project resource pages, community sites, and/or personal guru pages.

The object modeling tool, process modeling tool and user interfaces are used to build components of cross-functional applications to implement new enterprise management functions without requiring detail coding development by a system architect or programmer.

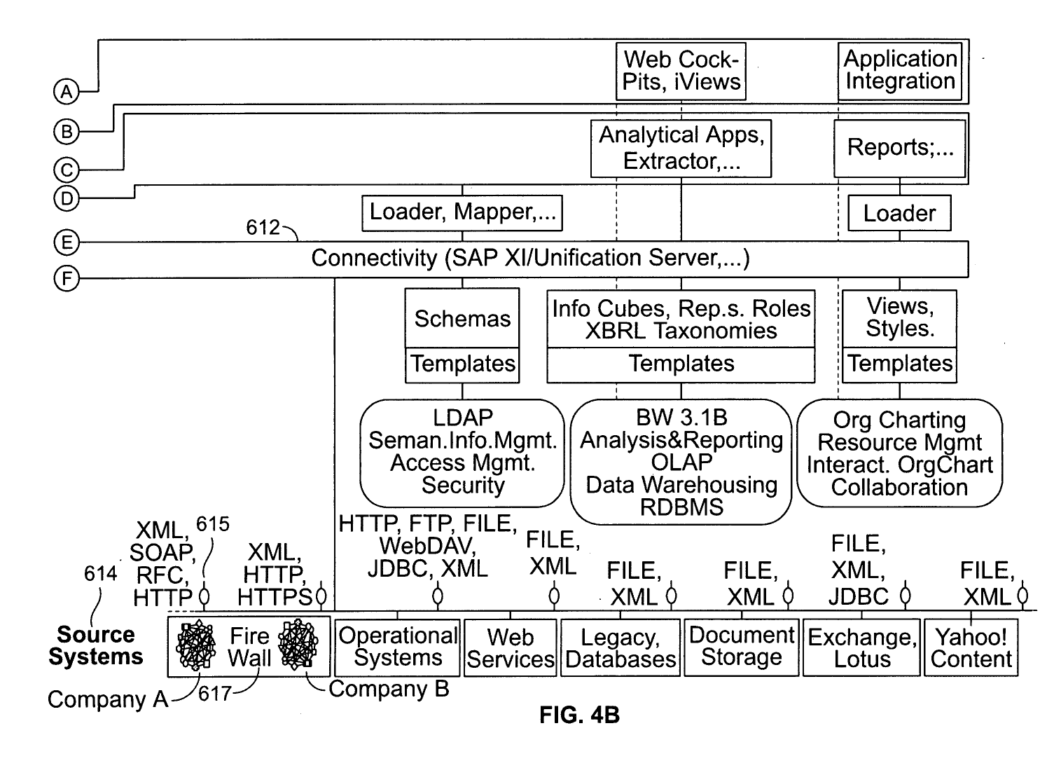

As shown in FIG. 4, a platform 600 that supports the architecture 500 includes a portal 602, user interface (UI) components 604 and application services logic 606. The platform 600 includes an object access layer 608, a persistence/repository layer 610, connectivity layer 612, and source systems 614. In embodiments, the architecture includes software and components from SAP AG of Germany, as well as special corporate restructuring modules.

Graphical user interfaces (GUIs) provide interaction between a user and the UI components 604 through the portal 602. The UI components 604 interact with the application services logic 606. The application services logic 606 interact with databases and repositories in the persistence/repository layer 610. The user requests information via a GUI through the portal 602. The application services logic 606 processes the user request, retrieves the appropriate requested information from the databases and repositories in the persistence/repository layer 610, and sends the requested information to GUI for display to the user.

The databases and repositories in the persistence/repository layer 610 can contain metadata. Metadata refers to data that describes other data, such as data pertaining to roles, work sets and personalization information, for example. The metadata can interact with the object access layer 608, connectivity layer 612 and application services logic 606. The metadata can also interact with templates 616. The templates 616 provide a format or organization of information according to preset conditions. The templates 616 can interface with Web application server (WAS) processes 618 and core merger processes 620 in the repository layer 610.

In embodiments, the databases and repositories in the persistence/repository layer 610 interact with the source systems 614 through base system connectors 615 using a markup language such as extensible markup language (XML), web services such as Simple Object Access Protocol (SOAP), request for comments (RPC), or Transmission Control Protocol/Internet Protocol (TCP/IP). The source systems of one organization can interact with the source systems of another organization through a firewall 617.

The base system connectors 615 can include a enterprise connector (BC) interface, Internet communication manager/Internet communications framework (ICM/ICF), an encapsulated postscript (EPS) interface and/or other interfaces that provide remote function call (RFC) capability.

The persistence/repository layer 610 provides the platform 600 with its own database and data object model. The database and data object model provides a consolidated knowledge base to support multiple enterprise functions, including functions generated as cross-applications. Active communication between the persistence/repository layer 610 and the base systems 516/614 provides a linkage between real time relational data from multiple base systems 516/614 and an integrated enterprise tool to permit strategic enterprise management and planning.

The data object model represents a subset of data objects managed by base systems 516/614. Not all of the data aspects tracked in the base systems 516/614 need to be recorded in the data object model. The data object model has defined relationships with data objects stored in the base systems 516/614. For example, certain data objects in the data object model have “read-only” or “write-only” relationships with data objects in the base systems 516/614. These types of defined relationships are enforced through a communication process between the persistence/repository layer 610 and the base systems 516/614. The persistence/repository layer 610 decouples application development from the underlying base systems 516/614.

In embodiments, the source systems 516/614 interact with third party applications, such as Lotus software from IBM or data provided by other content providers, such as Yahoo!

As described above, the portal 602 provides a common interface to management services. The management services include a merger project management service and a merger integration project management service. The network 504 links the clients 502 to the portal 602 for exchange of information pertaining to a merger of two organization organizations or an acquisition involving two organizations.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

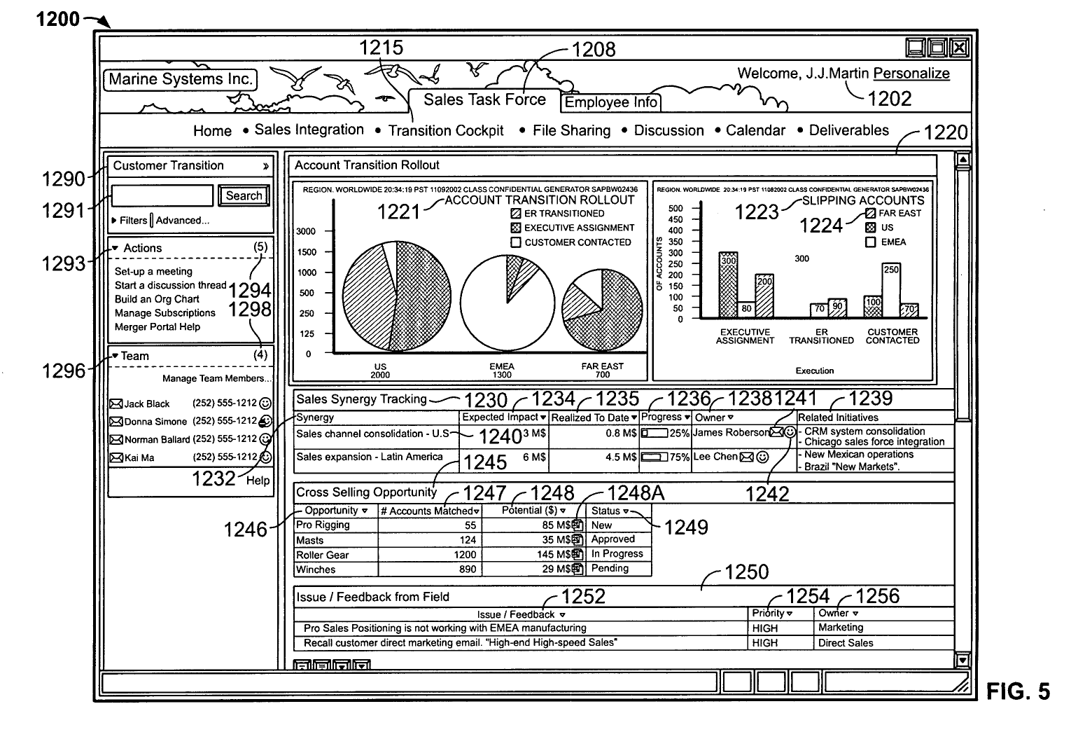

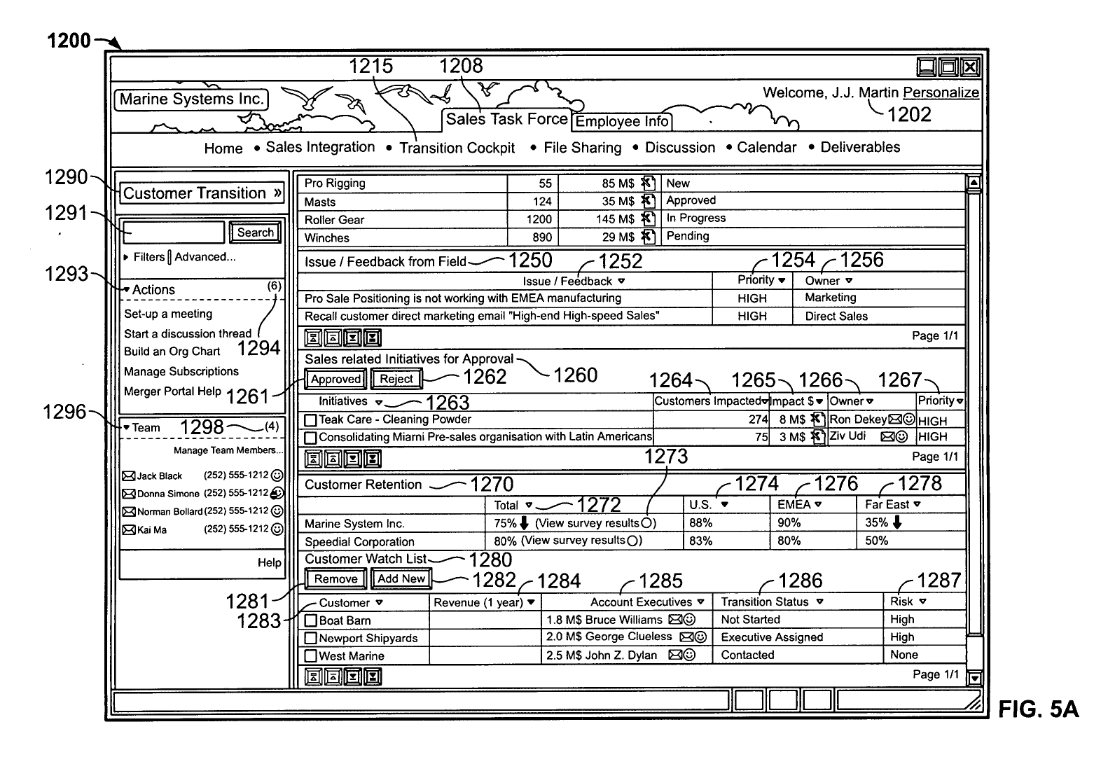

FIG. 5 shows an example of an interface 1200 for a stakeholder 1202 with access to a sales task force menu 1208. Other possible views for stakeholders in the sales task force interface 1200 include views for sales integration, file sharing, discussions, deliverables, and a calendar. The view presented in interface 1200 is a transition cockpit view 1215. The view 1215 allows the stakeholder 1202 to access and manage sales-related transition tools for the merger, including an account transition rollout 1220 and sales synergy tracking 1230. The account transition rollout 1220 presents graphs 1221 and charts 1223 of accounting information, including regional or divisional account information 1224 and accounts 1223 that are slipping from schedule.

The system 10 facilitates sales channel consolidation 1240 in the sales synergy tracking section 1230. The section 1230 can present a synergy 1232, an expected impact 1234, a realized impact 1235, and a progress 1236 of the expected impact. The expected impact progress 1236 is displayed as a percentage in a bar graph. The section 1230 can also show an owner 1238 of a synergy, along with a link for an email 1241 and a real-time messaging and availability utility 1242. Also, the section 1230 can present one or more initiatives 1239 related to the synergy 1232.

The availability feature or utility 1242 allows a stakeholder to send a private, real-time message to another user on the system 10. The availability utility 1242 can be a real-time alternative to email and allow a chat session outside of a chat room. The utility 1242 can be made by an external software tool from a unit of AOL Time Warner Inc. of New York, N.Y.

Interface 1200 further presents a panel 1245 to allow a user 1202 to view and analyze one or more user-identified cross selling opportunities. One or more stakeholders can identify one or more cross-selling opportunities 1246. The panel 1245 presents one or more opportunities 1246 and a number of accounts matched 1247 for each opportunity. A status 1249 and a potential value 1248 of each opportunity are evaluated and presented in a linked object 1248A.

The linked object 1248A can be an external software object, such as an Excel® spreadsheet by Microsoft Corporation. In general, objects can be internal or external to the disclosed software, but can coexist with each other.

FIG. 5 and FIG. 5A present an exemplary panel 1250 for issues or feedback 1252 from customers or other merger stakeholders. The feedback 1252 arrives from stakeholders who sell or market products or services to customers and includes a corresponding priority level 1254. The feedback 1252 provides the merger organizations with valuable information on marketing, selling, and advertising products and services. The feedback 1252 also allows a merger organization to identify strengths and weaknesses in organizational products, services, strategy, personnel, and goals during the merger process 1100. Moreover, the feedback 1252 allows merger organizations to track customer reactions to merger developments and announcements.

FIG. 5A further presents a panel 1260 for sales-related initiatives for approval from a stakeholder. The panel 1260 present buttons for approval 1261 and rejection 1262. The panel 1260 presents a checklist of initiatives 1263 with a number of impacted customers 1264, a financial impact 1265, an owner 1266 and a priority level 1267 for each initiative 1263. The interface 1200 can present a panel 1270 for each merger organization with a measure of customer retention 1272. The panel 1270 can present one or more retention rates 1271 for a division or region 1274, 1276, 1278. Alternatively, the interface 1200 presents customer satisfaction rates 1271, including customer surveys 1273. The customer survey 1273 is presented in an external object. Moreover, the panel 1270 indicates if there has been any movement (via an arrow) 1279 of the rates 1271 (e.g., increasing or decreasing rates 1271).

Furthermore, the interface 1200 has a panel 1290 with a text box 1291 to allow the user 1202 to search for items or people, as well as to perform a number 1294 of other actions 1293. The user 1202 can contact a number 1298 of merger team members 1296.

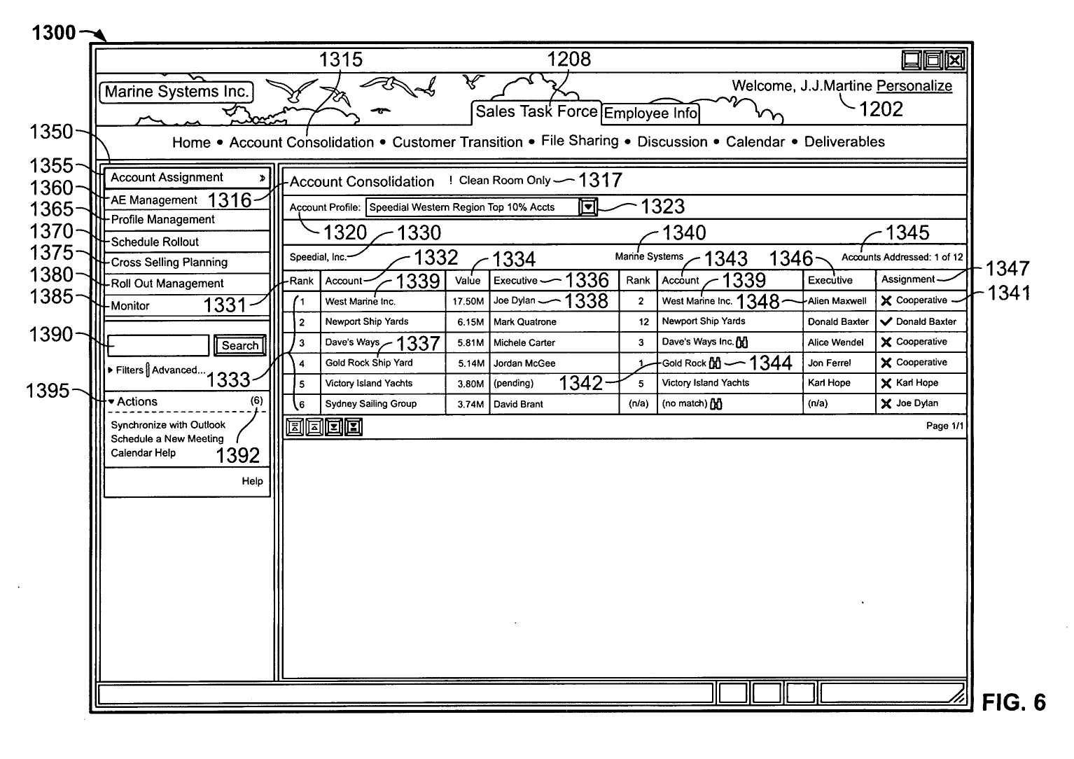

As shown in FIGS. 6-10 the system 10 includes a graphical user interface and can be adapted to consolidate customer accounts for at least one of the organizations.

FIG. 6 presents an interface 1300 to allow the user 1202 to consolidate customer accounts 1315 from the sales task force menu 1208. The interface 1300 presents an account profile 1320 of a merger organization 1330 and sort a list 1333 of customer accounts 1332 based on one or more predefined parameters in a pull down menu 1323. The interface 1300 identifies and matches similar accounts 1332, 1343 from at least two merger organizations 1330, 1340. The interface 1300 presents a value 1334 of each account 1332 for a number 1345 of accounts, and sort accounts 1332 by account values 1334.

Customer service personnel 1336, 1346 from each merger organization 1330, 1343 can be presented, and an assignment 1347 made for the person responsible for the account. For instance, Joe Dylan 1338 from Speedial, Inc. 1330 and Allen Maxwell 1348 from Marine Systems 1340 have a cooperative assignment 1341 for a West Marine Inc. account 1339. Alternatively, either executive 1336, 1346 from the merger organizations 1330, 1340 can individually be assigned to be responsible for a customer account 1332. When the customer names 1337, 1342 do not completely match, the user 1202 is allowed to manually select a customer from a list for exception listing. The user 1202 selects a link (e.g., icon 1344) to access the customer list.

The interface 1300 also presents a panel 1350 allowing a user 1202 to access one or more links to merger-related views, including an account assignment view 1355, an account executive (AE) management view 1360, and a profile management view 1365. Other linked views can include a schedule rollout view 1370, a cross selling planning view 1375, a rollout management view 1380, and a view 1385 for monitoring the merger process. The panel 1350 also allows the user to perform a search 1390, and perform a number 1392 of other merger-related actions 1395.

The interface 1300 also includes a tool to model a “clean room” environment 1317 during the merger process 1100. The clean room concept typically involves members of the involved organizations physically meeting in a room and exchanging information and objects. Typically, only the members of a clean room environment can view and examine the confidential and privileged information of other merger organizations. If the merger deal is unsuccessful and the merger deal fails, then the clean room members often leave their organization for reasons of conflicts of interest, or are transferred to other parts of their organization where they will not be interacting with the other merger organizations.

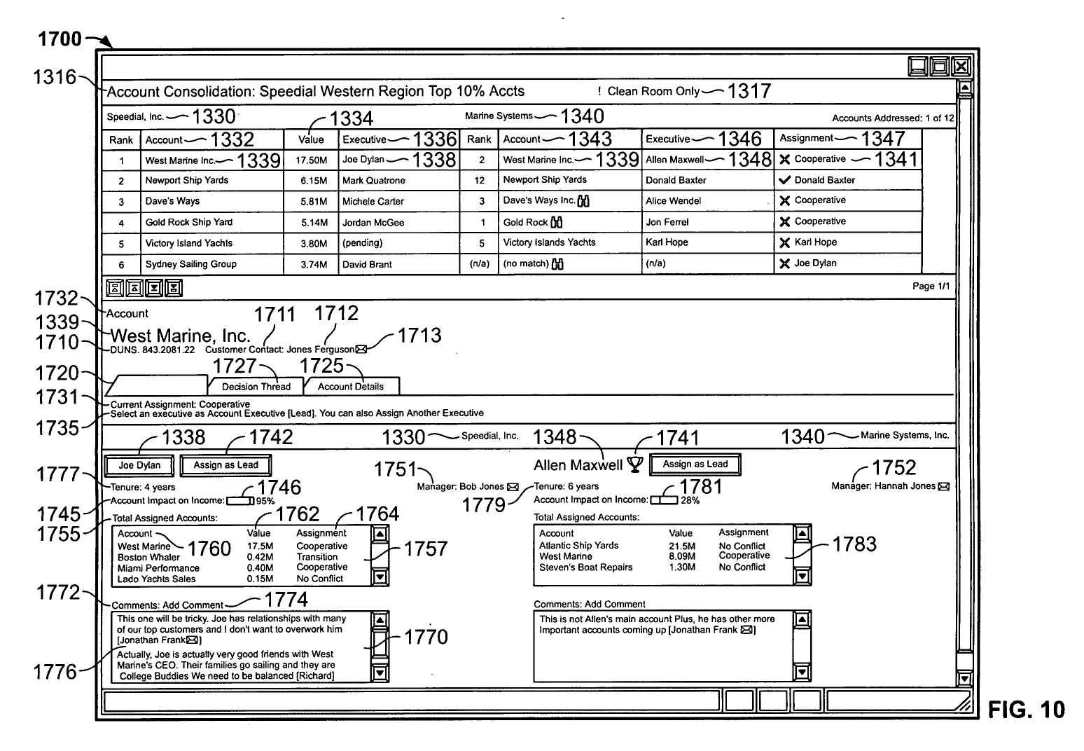

As shown in FIGS. 6 and 10, a graphical user interface is adapted to display customer account information for at least one of the organizations. The graphical user interface can include a menu that is adapted to display one or more views relating to account assignments, decision threads, and account details. The graphical user interface can further include an account identification number, a customer contact, a customer contact electronic mailing link, a measurement for an account impact, and an account assignment view. The account assignment view can include an assignment type, a selector relating to an account lead, and information relating one or more account executives. The account executive information can include at least one of a length of tenure, a notable achievement, a list of assigned accounts, and information relating to a management stakeholder. The list of assigned accounts can relate to at least one of the account executives, in which the list of assigned accounts can comprise assigned accounts, assignment information, and a text box.

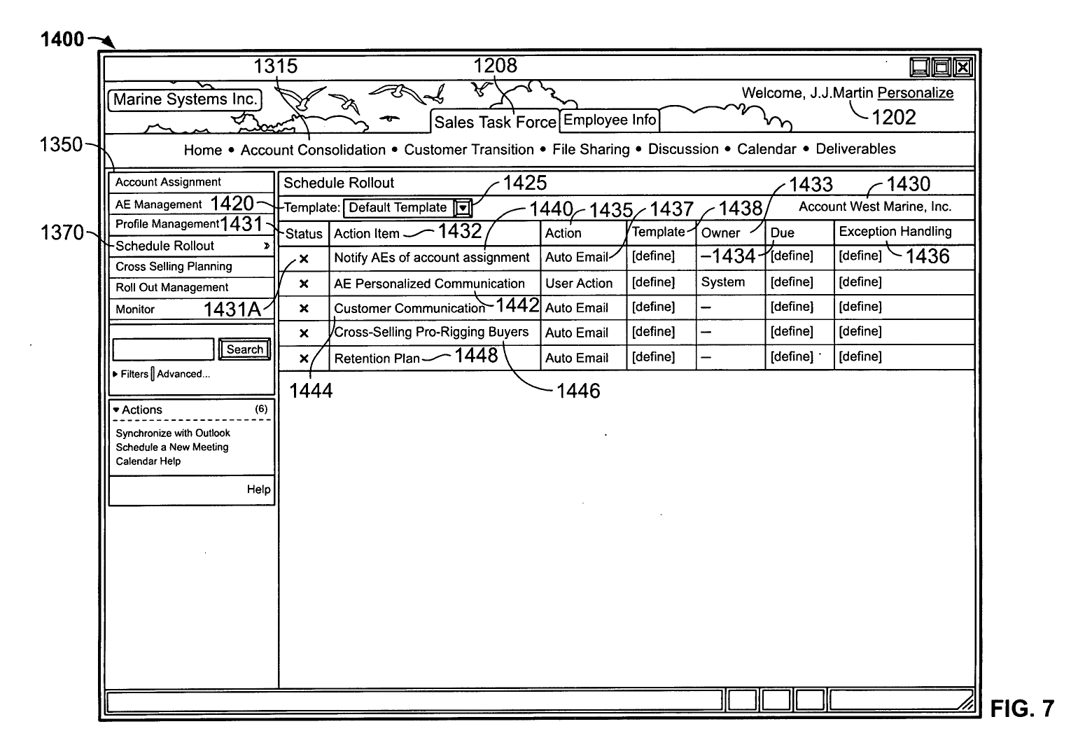

As shown in FIGS. 7-11, a user interface includes information relating to consolidating accounts for at least one of the merger organizations. The user interface can include a pull down window, a text box, a trigger date, and a response date. The user interface can also present a template including a notification template menu, a list of action items, and an owner relating to each action item in the list.

The list of action items can include at least one of an account executive assignment notification, an account executive personalized communication, a customer communication, a cross selling opportunity, and a retention plan. The action item can comprise a transmission of an email.

FIG. 7 presents an interface 1400 that allows a user 1202 to consolidate accounts 1315 in the sales task force menu 1208. The user 1202 can select to view a schedule rollout view via link 1370. The user 1202 can also view a schedule rollout template 1420 from a template format in a pull down menu 1425. The user 1202 examines a status 1431 of an action item 1432. A status indicator 1431A (e.g., an “X” indicator) signifies that the action has not been completed. The user 1202 can perform an action 1435, such as automatically sending an email 1437 and defining a template 1438. Additionally, an owner 1433 and a due date 1434 of the action item 1432 can be presented. The interface 1400 also facilitates exception handling 1436 for the action items 1432. Some exemplary action items 1432 include notifying an account executive (AE) of an assignment 1440, facilitating AE personalized communication 1442, and conducting customer communication 1444. Other exemplary action items 1432 involve a cross-selling opportunity 1446 and a retention plan 1448.

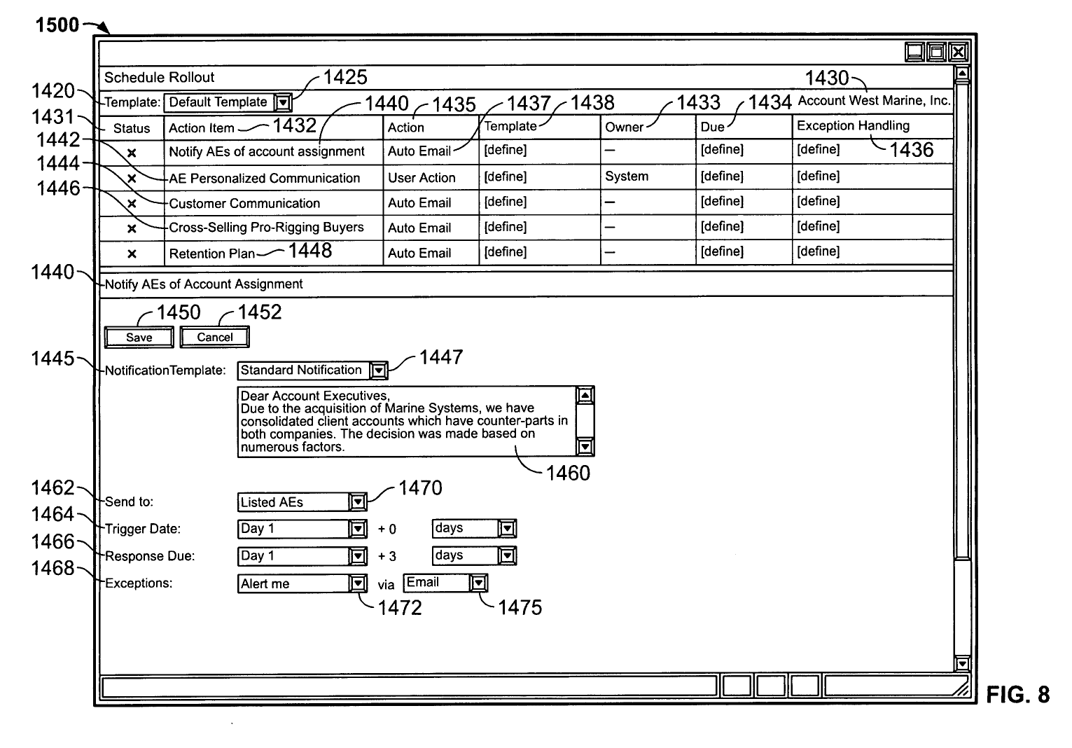

FIG. 8 presents an interface 1500 in which the user 1202 can select to notify an AE of an account assignment 1440. A notification template 1445 and a template format in a pull down window 1447 is presented. A message can be entered in a text box field 1460. The user 1202 can then send the assignment notification 1440 to one or more stakeholders shown in a pull down menu 1470. The notification 1440 can include a trigger date 1464 and a response date 1466. The interface 1500 also facilitates exceptions 1468 to the notification 1440, such as sending an alert email 1472, 1475.

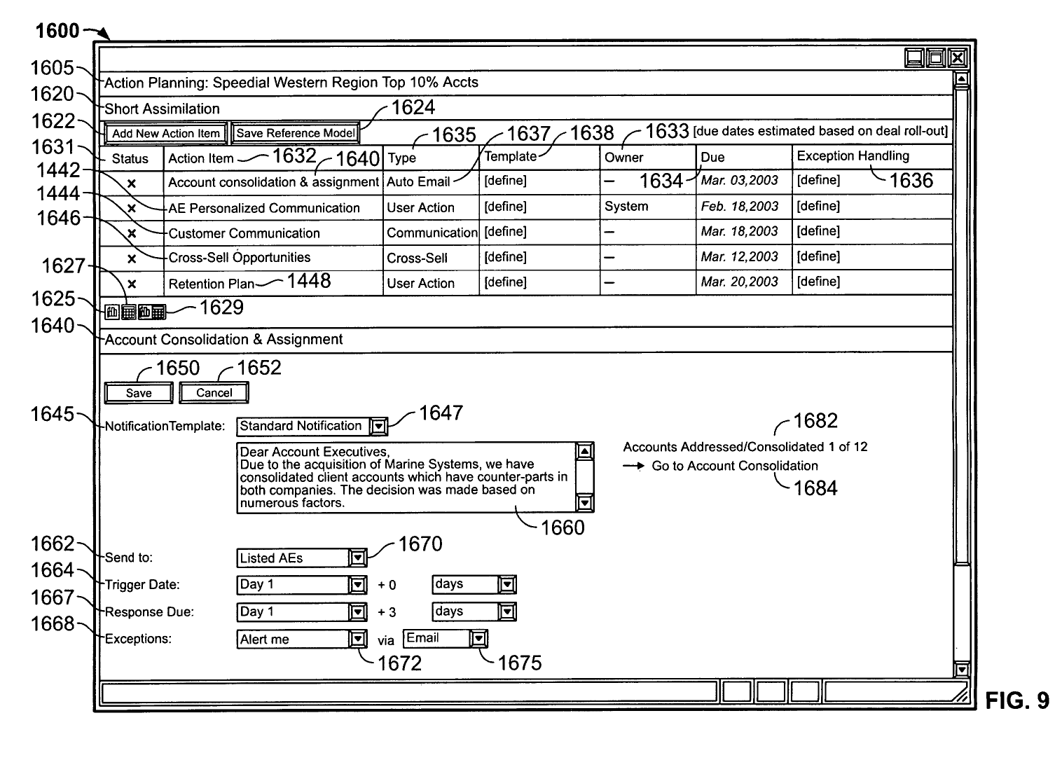

FIG. 9 presents an interface 1600 that facilitates action planning 1605 for one or more accounts. The interface 1600 includes a panel 1620 for an assimilation of action items 1632. The panel 1620 presents a status 1631 and an action type 1635 for each action item 1632 including an action type 1635 for automatically sending an email 1637. The panel 1620 can also include a template 1638, an owner 1633, a deadline 1634, and an exception handler 1636. Some exemplary action items 1632 can include account consolidation and assignment 1640, AE personalized communication 1442, and customer communication 1444. Other action items 1632 include cross selling opportunities 1646 and a retention plan 1448. The panel 1620 presents a graph 1625 of action items 1632, a list 1627 of action items 1632 or both graph 1625 and the list 1632 of action items 1629.

FIG. 9 additionally presents a panel 1640 for account consolidation and assignment. The panel 1640 presents a notification template 1645 and a template format in a pull down window 1647. A message or description can be entered in a text box field 1660. Account notification can be sent to one or more stakeholders listed in a pull down menu 1670. The notification includes a trigger date 1664 and a response date 1667. The interface 1600 facilitates exceptions 1668, such as sending an alert email 1672, 1675. Furthermore, the interface presents a number 1682 of consolidated or addressed accounts, and present a link 1684 to an account consolidation view.

An account consolidation interface 1700 in FIG. 10 can be presented from the link 1684 in interface 1600 in FIG. 9 or the interface 1700 can be presented from selecting an account 1332 in the account list 1333 in FIG. 6. Panel 1316 in interface 1700 can present similar account consolidation information as shown in the account list 1333. A user 1202 can select an account title 1339 to present additional account detail 1339 in another account panel 1732.

The panel 1732 shows the account 1339, an account identification number 1710, a customer contact name 1712, and an email link 1713 for the customer contact 1711. The account panel 1732 shows a tabbed menu for account assignments 1720, decision threads 1727, and other account details 1725. The decision thread 1727 presents a log of a collaborative decision process in which merger managers can exchange ideas and communications. The tab 1720 selected and presented in the interface 1700 is the account assignment tab 1720.

The interface 1700 presents a current assignment type 1731 and allows the user 1202 to select a lead person 1735 for the account 1339. The interface 1700 allows the user 1202 to examine and comparatively inspect account information for at least two of the merger organizations 1330, 1340. The interface 1700 shows one or more details for executives 1338, 1348 of the account 1339 for one or more merger organizations 1330, 1340. For example, the interface 1700 shows a manager 1751, 1752 and a length of tenure 1777, 1779 for each account executive 1338, 1348. An account executive 1348 having a notable achievement 1741 as shown. A measurement 1746, 1781 for an impact the account 1339 has on income 1745 for each organization 1330, 1340 can be shown.

The interface 1700 can present a list 1757, 1783 of total assigned accounts 1755 for each account executive 1338, 1348. Each list 1757, 1783 shows customer accounts 1760 with account values 1762 and assignment information 1764. Moreover, the interface 1700 can show a comment 1772 text box 1770 for a user to add comments 1774. The text box 1770 can have a link 1776 for discussed contacts.

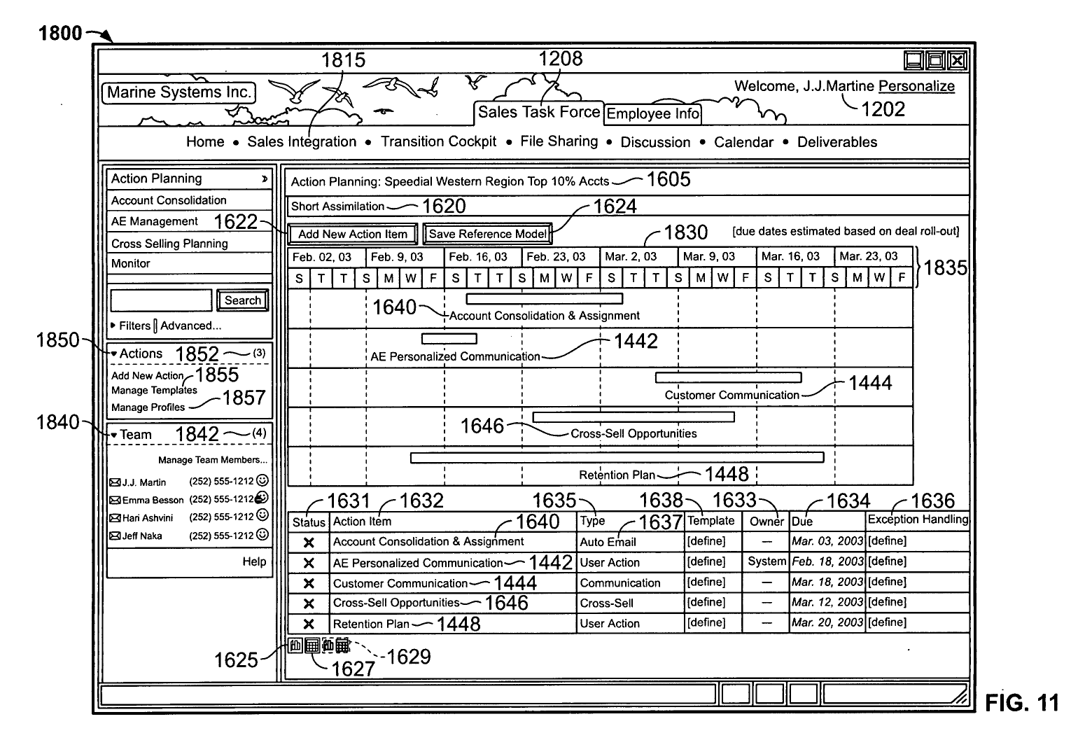

FIG. 11 presents an interface 1800 for stakeholder user 1202 for sales integration 1815 in the sales task force menu 1208. The interface 1800 facilitates action planning 1605 for one or more accounts, as shown in interface 1600. The interface 1800 presents a Gantt chart 1830 of the assimilation actions 1632. The Gantt chart 1830 presents a time period 1835 for each action 1632. The stakeholder 1202 can inspect the status 1631 of the action items 1632 to ensure customer satisfaction. The stakeholder 1202 can also contact a number 1842 of other sales task force members 1840, and access a number 1852 of actions 1850, such as managing templates 1855 and profiles 1857.

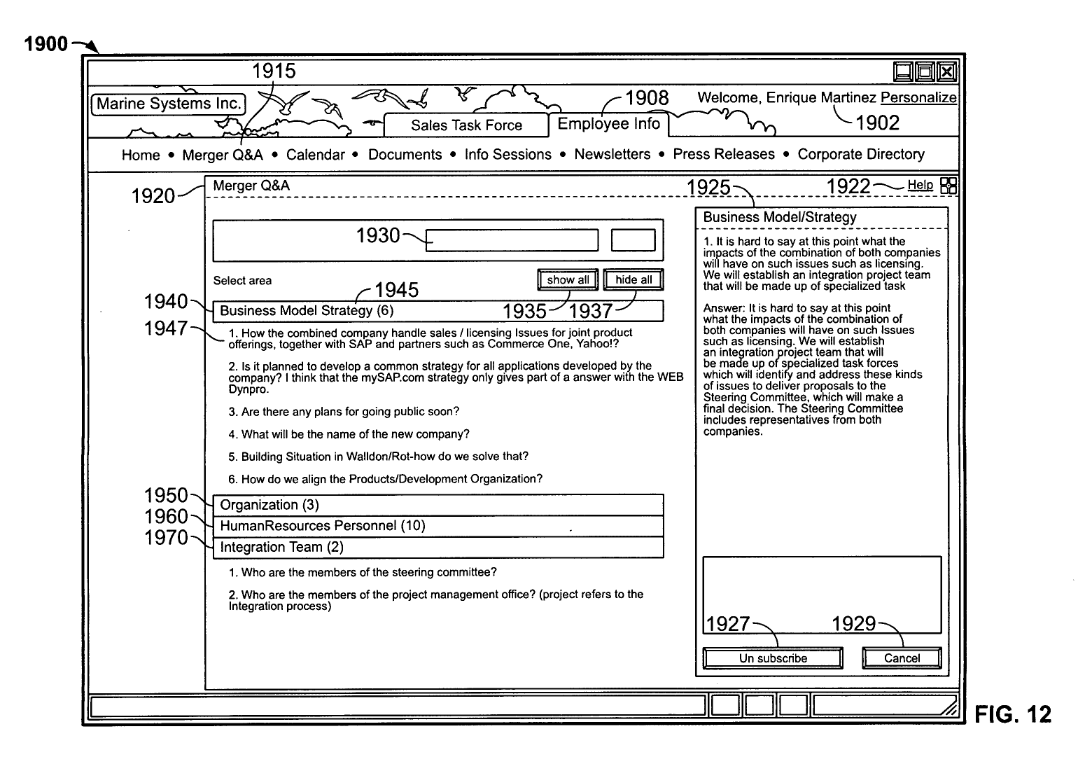

FIG. 12 presents an interface 1900 for a stakeholder 1902 to access a menu 1908 for employees with a panel 1920 for merger-related questions and answers (Q&A) 1915. The Q&A interface 1900 allows merger organizations to address commonly asked questions from employees. The interface 1900 presents a central, integrated Q&A format to address common questions and reduce an amount of misinformation and confusion that can arise during the merger process 1100.

The panel 1920 shows categories for various Q&A merger topics. As an example, some Q&A categories can include a business model and strategy category 1940, an organizational category 1950, a human resource and personnel category 1960, and an integration team category 1970. The user 1902 can select a single category 1940 to view a number 1945 of listed questions 1947 for that category 1940. Additionally, the user 1902 can select a button 1935 to show all listed questions for all categories or select a button 1937 to hide all questions for all of the categories. The user 1202 can further select a question 1947 to view a panel 1925 with a response or answer to address the question 1947. Employees to subscribe or unsubscribe 1927 can merger-related Q&A categories. The panel 1925 can be cancelled 1929 and closed by the user 1902. In the event the employee stakeholder 1902 has other questions or desires other resources, the interface 1900 can provide a text box 1930 for searches and a link 1922 for help and reference views.

Other embodiments can be within the scope of the following claims.

What is claimed is:

1. A method for managing a corporate restructuring of at least two organizations, the method comprising:
presenting a user interface including information relating to consolidating customer accounts for at least one of the restructuring organizations; and
presenting a template in the user interface, the template including a rollout template menu, a pull down window, a list of action items, and a status relating to each action item in the list.

2. The method of claim 1 wherein the list of action items comprises at least one of an account executive assignment notification, an account executive personalized communication, a customer communication, a cross selling opportunity, and a retention plan, an action including a transmission of an email.

3. A method comprising:
providing a single logical physically distributed information system across one or more information systems of at least two enterprises being combined; and
providing a user interface to allow a user to access the single logical physically distributed information system to execute one or more pre-merger activities, merger activities, and post-merger activities, the merger activities including customer-related integration and resources, the post-merger activities including a post-merger assessment and a measurement of one or more achieved merger synergies.

4. The method of claim 3, wherein the merger activities further comprise:
providing customer-related communications; and
managing and planning customer support activities, the customer support activities including addressing one or more customer issues and concerns.

5. The method of claim 3, wherein the user interfaces are adapted to a role of the user and a phase of the merger, the user role including an executive of one or more customer accounts, a security of the user interface related to the phase of the merger and a role of the user.

6. A method comprising:
facilitating consolidation of customer-related information for a first organization being merged with a second organization, the customer-related information including customer accounts, the consolidation including matching one or more customer accounts of the organizations; and
facilitating consolidation of customer-related assignments of at least one of the organizations.

7. The method of claim 6 further comprising:
providing an exception list for non-matched customer accounts; and
tracking a status of customer-related engagements.

8. A system for managing a merger of at least two organizations, wherein the system comprises a software process and user interface adapted to assist customer satisfaction during a merger period, the software process being stored in a medium.

9. The system of claim 8 further comprising:
a first tool adapted to retain one or more customers;
a second tool adapted to provide collaborative customer retention planning; and
a third tool to provide targeted and personalized electronic mailing to customers of at least one of the organization.

10. The system of claim 9, wherein the second tool is adapted to provide a unified and aligned presentation of customer accounts from one or more merger customer support centers of at least one of the organizations, the presentation including customer records.

11. A system for implementing a merger of at least two organizations, the system including a software product adapted to facilitate sales-related activities of the organizations, the software product including a user interface, wherein the sales-related activities include at least one of sales consolidation, cross selling activities, and customer retention of the organizations.

12. The system of claim 11, wherein the user interface presents at least one of a synergy, an expected impact, a realized impact, and a progress of the expected impact, the user interface presents the progress in a graph and at least one of an owner of the synergy, an electronic mailing link, and one or more initiatives related to the synergy.

13. The system of claim 11, wherein the user interface presents information for one or more user-identified cross selling opportunities, the information including a number of matched customer accounts, a status, and a potential value, the potential value associated with an external object.

14. The system of claim 11, wherein the user interface comprises:
a first panel adapted to address customer-related issues;
a second panel adapted to address sales-related initiatives, the second panel including at least one of an approval button, a rejection button, a checklist of initiatives, a number of impacted customers, a financial impact, an initiative owner, and an initiative priority level;
a third panel adapted to facilitate customer retention, the third panel including a measure of customer retention, one or more retention rates, and a movement of the one or more rates;
a fourth panel adapted to facilitate customer retention, the fourth panel including at least one of a customer satisfaction rate, a customer survey, and a movement of the rate, wherein the customer survey comprises one or more external objects; and
a fifth panel adapted to facilitate a search of merger information and to facilitate contacting one or more merger members.

15. A system for managing a merger of at least two organizations, the system comprising a graphical user interface adapted to allow a user to consolidate customer accounts for at least one of the organizations, the graphical user interface further adapted to match customer accounts from at least two merger organizations.

16. The system of claim 15, wherein the graphical user interface comprises a sorted list of customer accounts, a customer account value, a numerical representation of account ranking, information for at least one customer service personnel from each merger organization, information for a customer service personnel assignment relating to at least one account, the customer service personnel assignment including a cooperative assignment.

17. The system of claim 15, wherein the graphical user interface further comprises information relating non-matched accounts and a clean room tool adapted for at least one stakeholder, the information relating to non-matched accounts including a second list of customer accounts.

18. A method for managing a merger of at least two organizations comprising:
presenting a user interface including information relating to consolidating accounts for at least one of the merger organizations, the user interface including a pull down window, a text box a trigger date, and a response date; and
presenting a template in the user interface, the template including a notification template menu, a list of action items, and an owner relating to each action item in the list.

19. The method of claim 18, wherein the list of action items comprises at least one of an account executive assignment notification, an account executive personalized communication, a customer communication, a cross selling opportunity, and a retention plan, an action item includes transmission of an email.

20. The method of claim 18 further comprising facilitating exception handling for at least one of the action items.

21. The method of claim 18, wherein the user interface further presents at least one of a list and a graph, the graph presents a time period for each listed action.

22. A system for managing a merger of at least two organizations comprising a services unification module, the services unification module including one or more user roles, the user roles including at least one of customers, services taskforce members, service representatives, and integration project managers.

23. The system of claim 22, wherein the services unification module comprises one or more inputs, the inputs comprising:
a list of customer accounts;
a list of products sold to one or more customers;
a list of customer-related services;
a list of customer-related personnel; and
a list of service providers.

24. The system of claim 22, wherein the services unification module further comprises one or more outputs, the outputs comprising:
an account services consolidation plan;
a merged account repository;
a customer communication;
a tracking statistic; and
a customer-satisfaction statistic.
